(19) United States
(12) Patent Application Publication
(10) Pub. No.: US 2008/0200056 A1
(43) Pub. Date: Aug. 21, 2008

(54) Tool-Free Microphone Connector

(76) Inventor: Vicky HUANG, Kaohsiung City (TW)

Correspondence Address: Dr. BANGER SHIA;Int''l Patent Office of Bang Shia, 102 Lindencrest Ct, Sugar Land, TX, 77479-5201, US

(21) Appl. No.: 11/677,105

(22) Filed: Feb. 21, 2007

(51) Int. Cl. H01R 13/62

(52) U.S. Cl. 439/310

(57) ABSTRACT

A tool-free microphone connector assembly with non-threaded engagement between parts is provided. New improvements in the present invention include a main body housing, a rear sleeve, and an annular tightening loop. The main body housing comprises a pressing button disposed thereon, a locking tube with a non-threaded outer tubular surface, and two projecting locking pieces. Each projecting locking body defines a locking contact and a guiding slope. The rear sleeve of flexure materials comprises a through bore at its one end and an engaging contact at the other end.

### BACKGROUND OF THE INVENTION

1. Field of the Invention

This invention relates to a microphone connector assembly, particularly to one firmly attached together as a unit through non-threaded engagement and without applying assembly tools.

2. Description of the Related Art

A microphone is provided with a microphone connector for connection with a cable. A conventional microphone connector comprises a main body 1′, a plurality of terminals 2′, a cylindrical main body housing 3′, a cord clamping sleeve 4′, and a rear sleeve 5′, as shown in FIG. 7 and FIG. 8. Most conventional microphone connectors resort to threaded engagement in assembly, and may also require tools in assembly. U.S. Pat. No. 6,814,601 by Lin is one of these cases: a rear male threaded portion is engaged with a rotatable constrict ring for securing. Furthermore, a screw is utilized in fastening the rotatable constrict ring to the microphone through a threaded hole of the rotatable constrict ring.

For more related arts of the present invention, please refer to FIG. 7 and FIG. 8. The main body 1′ is configured with several through-holes 11′ for insertion of a plurality of terminals 2′. The end of terminals 2′ connects to a cable 6′ to conduct electricity. An elastic piece 21′ is disposed at the other end of the main body 1′, opposite to the end of terminals 2′. The main body housing 3′, which receives the main body 1′, is a hollow cylinder composed of three cylindrical sections of various diameters. On the lateral side of the middle cylindrical section of the main body housing 3′ is provided with a pressing button 31′. The pressing button 31 ′ can be pressed down to reach against the elastic piece 21′ of the main body 1′. The engaging member 311′, next to the pressing button 31′, is attached to the main body 1′ in assembly. An annular threaded wall 32′ is disposed upon the outer surface of the rear cylindrical section of the main body housing 3′.

A cord clamp 4′ is composed of several cord clamping posts 43′, each in the shape of a divided section of a headed cone. A plurality of axially extended grooves 41′ are formed in between neighboring cord clamping posts 43′. A cord receiving space 42′ is defined by its surrounding cord clamping post 43′.

The rear sleeve 5′, shaped like an ice-cream cone with both ends open, is hollow within and is configured with through bores 51′ for a cable 6′ to go through. At the rear end of the rear sleeve 5′ is provided with a threaded section 52′ for engaging with the annular threaded wall 32′ of the main body housing 3′. Corresponding to the cord clamping posts 43′ is disposed a compressing member 53′ inside the rear sleeve 5′.

When in assembly, the terminals 2′ (disposed inside the main body 1′) first connects to the cable 6′, which goes in through the cord clamp 4′ and the rear sleeve 5′. The main body 1′ and the cord clamp 4′ are then housed inside the main body housing 3′. Finally, the threaded section 52′ of the rear sleeve 5′ is rotated to mesh in with the annular threaded wall 32′ of the main body housing 3′. As a result, both the main body 1′ and the terminals 2′ are housed inside the main body housing 3′ as well as the rear sleeve in such a way that the former (i.e. the main body 1′ and the terminals 2′) will not easily fall off from the main body housing 3′.

A disadvantage associated with the above-referenced prior art is that in assembly of the product, manual rotation for a threaded engaging is required between the threaded section 52′ (of the rear sleeve 5′) and the annular threaded wall 32′ (of the main body housing 3′). A second disadvantage is that a loose attachment between the microphone and the connector may occur when the microphone is inappropriate or accidentally rotated, which loosens up the threaded engagement between the threaded section 52′ and the annular threaded wall 32′.

### SUMMARY OF THE INVENTION

It is the goal of this invention to provide some feasible solutions for the defects encountered in the afore-mentioned prior arts. In it therefore an object of this invention to provide a tool-free microphone connector assembly with non-threaded engagement in assembly.

Compared with the prior arts, improvements in the present invention are made in the following ways.

1. The annular threaded wall (located at the rear end of the cylindrical main body housing) in the related prior arts is replaced with an annular non-threaded wall with two projecting locking bodies, configured on the top and bottom thereof. Each locking piece has a guiding slope inclined toward the center of the annular engaging tube.

2. A barrel-like rear sleeve is configured to correspond to the physical structure of the main body housing equipped with projecting locking bodies in such a way that the former (i.e. the rear sleeve) is locked with the later (i.e. the main body housing). For the unitary appearance of the final product, the thickness of the engaging piece of the barrel-like rear sleeve is made to correspond essentially to its to-be-engaged partner of the main body housing.

One advantage associated with the present invention is that the unique physical construction of the main body housing together with the rear sleeve offer a tool-free convenient assembly. A second advantage is that the projecting locking body (of the main body housing) comes in direct contact with the corresponding rear side of the elastic piece (of the rear sleeve), ensuring stability of assembly.

### BRIEF DESCRIPTION OF THE DRAWINGS

These and other features and advantages of this invention will become apparent in the following detailed description of the preferred embodiment of this invention, with reference to the accompanying drawings, in which:

FIG. 1 is an exploded perspective view of the first preferred embodiment in accordance with the invention;

FIG. 2 illustrates the initial assembly processing of the first preferred embodiment in FIG. 1;

FIG. 3 illustrates the assembly processing after the step shown in FIG. 2;

FIG. 4 is the assembly view of the first preferred embodiments in FIG. 1;

FIG. 5 is a cross-sectional view of the first preferred embodiment in FIG. 1;

FIG. 6 is a cross-sectional view of the second preferred embodiment in accordance with the present invention;

FIG. 7 illustrates the essential parts in assembling a conventional microphone connector; and

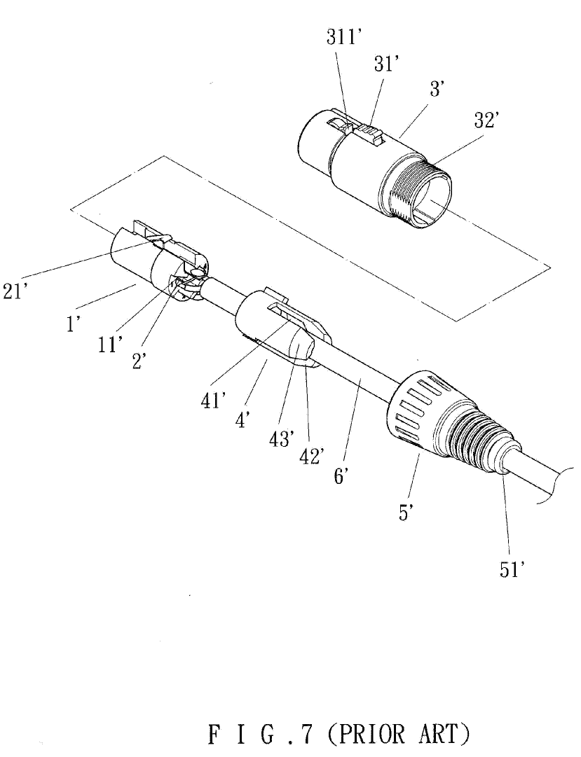

FIG. 8 illustrates a cross-sectional view of a conventional microphone connector.

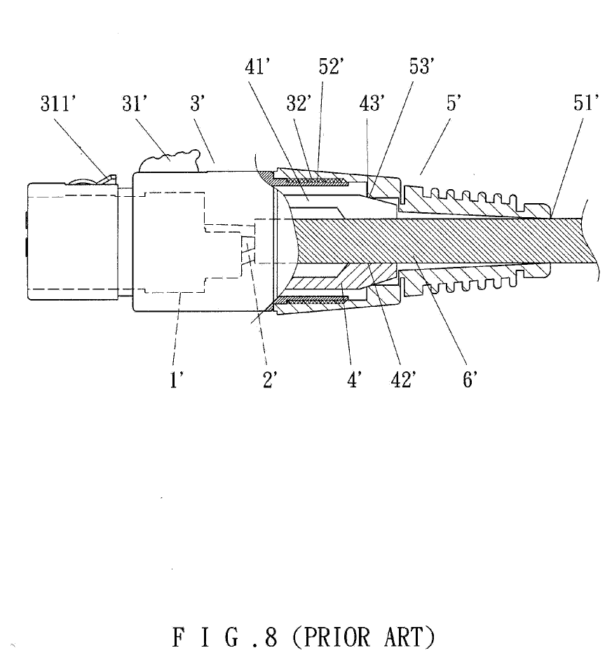

### DETAILED DESCRIPTION OF THE PREFERRED EMBODIMENTS

Parts or elements referred to in the invention with a symmetrical structure and identical functions are designated by the same reference numerals throughout the entire disclosure.

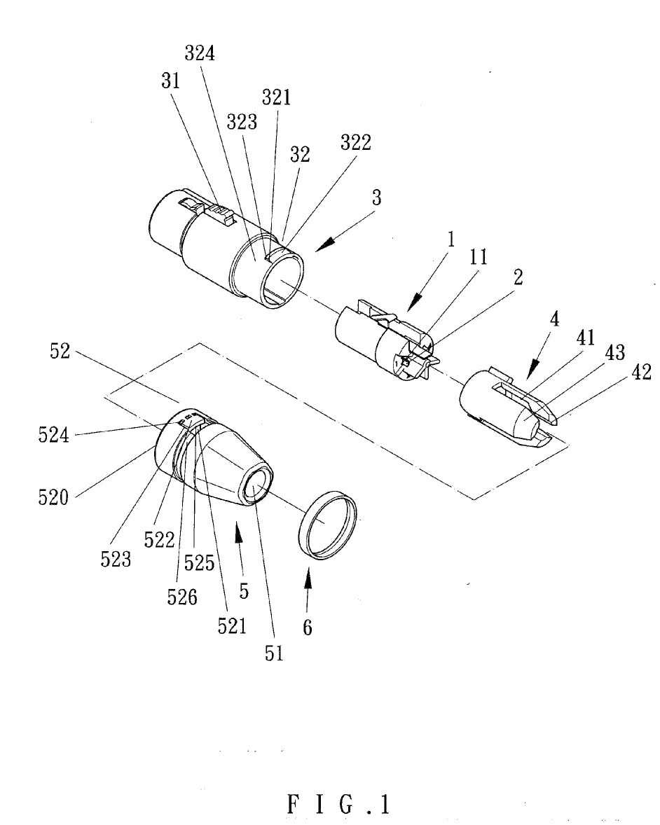

Referring to FIGS. 1-3, the first preferred embodiment of this invention includes the following parts: a main body 1, a plurality of terminals 2, a main body housing 3, a cord clamp 4, a rear sleeve 5 and an annular tightening loop 6.

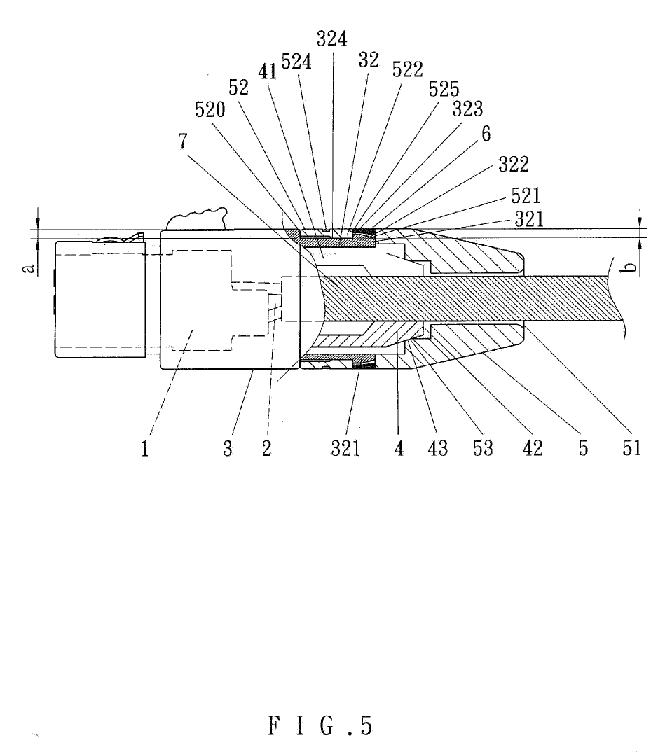

Similar to the above-discussed prior art, several through holes 11 are configured in the main body 1 for disposing terminals 2, as FIG. 1 shows. The main body housing 3, which receives the main body 1, is a hollow cylinder composed of cylindrical sections of various diameters, the front, intermediate, and the rear tube. A pressing button 31 is disposed on the outer wall of the intermediate cube, which can elastically move up and down. The rear tube, the locking tube 32, is covered by a non-threaded outer tubular surface 324, and is further configured with two projecting locking bodies 321 (also shown in FIG. 5) on the top and bottom of the non-threaded outer tubular surface 324. Each projecting locking body 321 defines a locking contact 323, and a guiding slope 322 inclining towards the center of the locking tube 32.

The cord clamp 4 is also similar to the previously discussed prior art, composed of several cord clamping posts 43, each in the shape of a divided section of a headed cone. A plurality of axially extended grooves 41 are formed in between neighboring cord clamping posts 43. A cord receiving space 42 is defined by its surrounding cord clamping posts 43.

The barrel-like rear sleeve 5 is hollow within, made of materials of flexure with a through bore 51 at its one end and an engaging contact 52 at the other. The engaging contact 52 defines an engaging opening 520. Referring to FIG. 5, the thickness a of the engaging contact 52 is made to correspond to the margin b in such a way that the size of a is somewhat less than b. The margin b is defined as the axial distance between a point A on the circumference of the non-threaded outer tubular surface 324, and a point B on the circumference of the intermediate tube (of the main body housing 3); an imaginary line connecting point A and B shall go through the center of the main body housing 3.

Two engaging slots 521 are provided over the engaging contact 52, each corresponding to the projecting locking body 321 (of the main body housing 3). Inside the engaging slot 521 is disposed an elastic piece 522, flanked on both lateral sides with a cavity 523, and equipped in the front with a plurality of inlets 524. The elastic piece 522 can move with flexure by way of these inlets 524. The rear side 525 of the elastic piece 2 corresponds to the outer front side of the projecting locking body 321 in such a way that the former (i.e. the elastic piece 2) becomes in contact against the later (i.e. the projecting locking body 321) after being assembled. An annular female groove 526 is provided over the outer surface of the engaging piece 52. Inside the rear sleeve 5 is further configured with a compressing portion 53, which can be in close contact with the cord clamping post 43, as shown in FIG. 5.

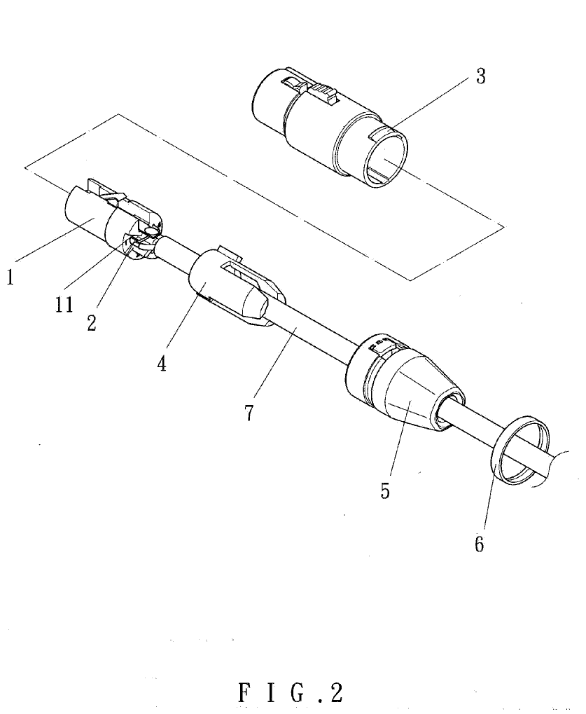

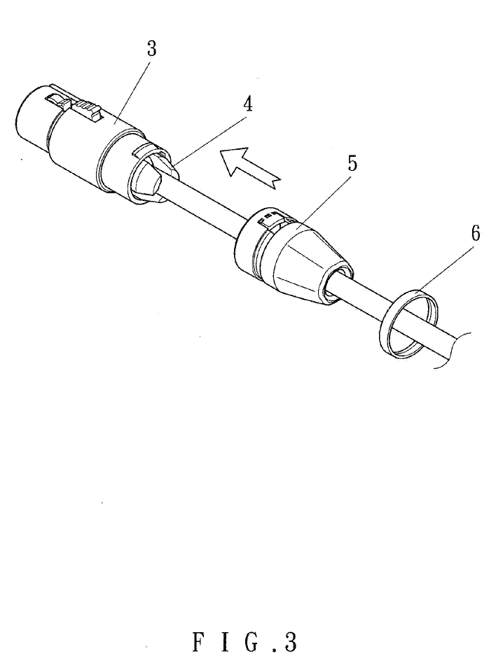

Referring to FIG. 2, sequential steps in assembly are given below. As the first step, a plurality of terminals 2 are inserted inside the through-holes 11 of the main body 1 in such a way that the cable 7 is electrically communicated to terminals 2. As FIG. 3 shows, the cable 7 then extends through the cord clamp 4 and the rear sleeve 5, and the main body 1 and the cord clamp 4 are housed inside of the main body housing 3.

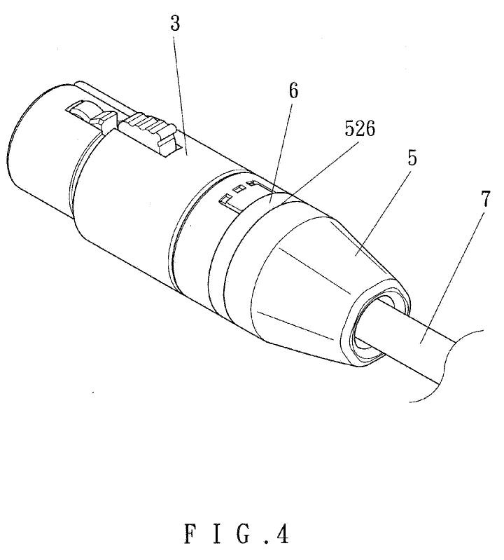

Referring again to FIG. 4 and FIG. 5, the rear sleeve 5 is then displaced in such a way that the engaging opening 520 (of the engaging piece 52) is mounted onto the rear of the main body housing 3 by way of the flexure property of the engaging opening 520. As a result, the projecting locking body 321 fits into the engaging slot 521. As a final step in assembly, the annular tightening loop 6 is mounted over its corresponding annular female groove 526, and covers up the engaging slot 521. Since the projecting locking body 321 is configured to correspond the rear side 525 of the elastic piece 2, the rear sleeve 52 is firmly secured. Even when a user inappropriately rotates the microphone he is holding (not shown in the figures), the rear sleeve will not fall off.

Furthermore, due to its flexure, the elastic piece 522 is capable of displacing along the guiding slope 322 when the rear sleeve 52 is mounted onto the main body housing 3, and is also capable of returning back to its original position when the engaging slot 521 is placed at the projecting locking body 321, contributing to great convenience in assembly of the present invention. As a final touch for adding to the overall unitary appearance and the positioning of parts, the annular tightening loop 6 covers up the engaging slot 521.

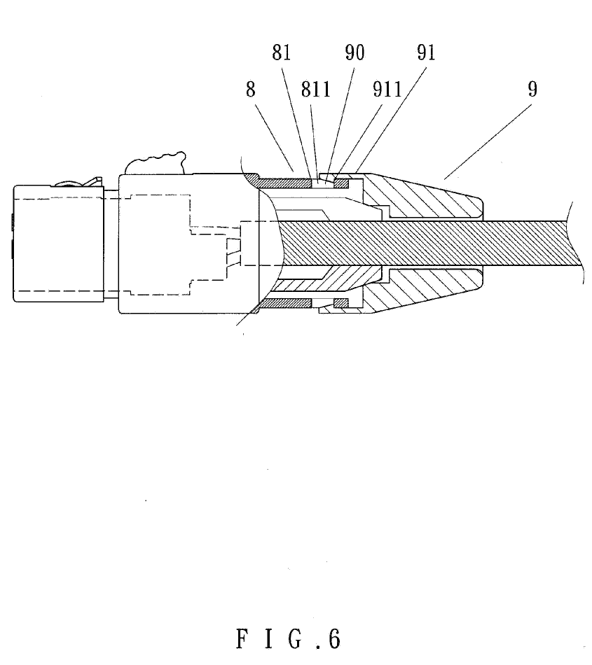

FIG. 6 shows a second preferred embodiment of the present invention. At the rear of the main body receiver 8 is provided a fixing member 81 with the bore 811. While at the front of the back sleeve 9 are disposed fixing opening 90, and fixing part 91. Corresponding to the bore 811, the fixing body 911 (of the fixing part 91) is provided. Due to its flexure property, the back sleeve 9 can be displaced to engage the rear of the main body receiver 8, while the fixing body 911 is fixed with the bore 811.

While the present invention has been described in connection with the most practical and preferred embodiment, it is understood that this invention is not limited to the disclosed embodiment but is intended to cover various arrangement included within the spirit and scope of the broadest interpretation so as to encompass all such modifications and equivalent arrangements.

I claim:

1. A microphone connector comprising
a main body provided with terminals therein;
a hollow main body housing provided with an engaging part at one end thereof for engaging with said main body;
a cord clamp;
a hollow rear sleeve made of flexure materials provided with an engaging piece at one end and with a through bore at the other, wherein said hollow rear sleeve is capable of being displaced for said engaging piece (of said hollow rear sleeve) to fix to said engaging part (of said hollow main body housing); and
annular tightening loop.

2. The microphone connector as claimed in claim 1, wherein said engaging part of said hollow main body housing comprises projecting locking bodies, and said engaging piece (of said hollow rear sleeve) comprises an engaging opening, and an engaging slot configured to correspond to each said projecting locking body (of said engaging part of said hollow main body housing).

3. The microphone connector as claimed in claim 1, wherein said engaging piece (of said hollow rear sleeve) is configured with an annular female groove around said engaging slot for being mounted by said annular tightening loop.

4. The microphone connector as claimed in claim 2, wherein
the front side of each said projecting locking body defines a locking contact,
the outer top side of each said projecting locking body defines a guiding slope inclining towards the center of said main body housing, and
the outer tubular surface upon which said projecting locking body located defines a tubular contact; and said microphone connector comprises
an elastic piece of flexure, configured in front of said engaging slot (of said rear sleeve), comprising
a rear side to come in contact against the front side of said projecting locking body,
a plurality of inlets thereon, and
a cavity on each lateral side.

5. The microphone connector as claimed in claim 4, wherein the thickness a of the engaging contact is made to correspond to the margin b in such a way that the size of a is in appreciably less than b, whereas said margin b is defined as the distance between a point A on the circumference of said tubular contact and a point B on the circumference of the tube on top of which said projecting locking body located, and an imaginary line connecting point A and B shall go through the center of said main body housing.

6. The microphone connector as claimed in claim 1, wherein said main body housing is provided with a fixing member with a bore, and said rear sleeve is provided with a fixing part comprising a fixing opening, and a fixing body for locking with said bore (of said fixing member of said main body housing).
